(19) United States
(12) Patent Application Publication
(10) Pub. No.: US 2008/0087337 A1
(43) Pub. Date: Apr. 17, 2008

(54) Hydraulic system for supplying hydraulic fluid to a component

(75) Inventors: Marco Grethel, Buhlertal (DE); Uwe Bastian, Gaggenau (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhi (DE)

(21) Appl. No.: 11/903,206

(22) Filed: Sep. 20, 2007

(30) Foreign Application Priority Data
Sep. 21, 2006 (DE) 10 2006 044 536.8

(51) Int. Cl. F15B 13/04; F16K 11/00; F16K 31/02

(52) U.S. Cl. 137/565.16; 251/337

(57) ABSTRACT

A hydraulic system for supplying hydraulic fluid to a wet clutch, including a pump that transports the hydraulic fluid from an oil reservoir to the wet clutch through a control valve that is operated electromechanically, in particular by means of a solenoid. The control valve is a selector valve, and includes a valve position in which a pressure side of the pump is connected to a suction side of the pump, or alternatively, to the oil reservoir.

### BACKGROUND OF THE INVENTION

1. Field of the Invention

The present invention relates to a hydraulic system for supplying a hydraulic fluid to a wet clutch.

2. Description of the Related Art

Suction-side-throttled oil pumps for wet clutches, specifically for double clutches, are known from published German application DE 10 2005 027 610 A1, for example. Those suction-side-throttled pumps can serve at least two and in most cases three different cooling oil needs of the wet clutch. That necessitates a valve function, which is preferably integrated onto or into the pump. One valve position, preferably the normal valve position, covers the need for cooling oil in the driving mode. That need is small in comparison to the active cooling needed when accelerating the vehicle from a stop and when shifting the transmission. For active cooling when starting off and when shifting, another valve position is used in which the cooling oil is conducted to the wet clutch without throttling. In a third valve position the flow of the cooling oil is interrupted when synchronizing the partial transmissions in parallel shift transmissions, so that no cooling oil reaches the clutch or clutches.

A hydraulic system is known from published German application DE 197 08 597 C1, in which the cooling oil requirement of a component is controlled by means of a pressure relief valve whose control spool is connected to the pressure side of the pump.

A disadvantage of solutions in accordance with the existing art is a relatively long shut-off time for the cooling oil flow. An object of the present invention is therefore to effect an improvement in the switching time of the cooling oil flow.

### SUMMARY OF THE INVENTION

The object is achieved by a hydraulic system for supplying a hydraulic fluid, in particular a cooling and lubricating medium such as hydraulic oil, to a wet clutch. A pump conveys the hydraulic fluid from an oil reservoir to the wet clutch through a control valve that is operated electromechanically, in particular by means of a solenoid. The control valve is a selector valve and includes a valve position in which a pressure side of the pump is connected to a suction side of the pump or to the oil reservoir.

Preferably there is provision for the control valve to include a valve spool that is biased into a home position, preferably one of the valve positions, by a spring having a spring characteristic that is graduated over the spring operating excursion, where the spring having a spring characteristic that is graduated over the spring operating excursion is preferably a parallel connection of at least two springs of differing spring length when the springs are in a non-loaded state.

The control valve is preferably a 4/directional flow control valve, with a connection to the oil reservoir, a connection to the suction side of the pump, a connection to the pressure side of the pump, and a connection to the oil inlet of the wet clutch. Alternatively, the control valve is a 5/directional valve, with two connections to the oil reservoir, a connection to the suction side of the pump, a connection to the pressure side of the pump, and a connection to the oil inlet of the wet clutch.

By particular preference, the control valve is a 3/directional flow control valve, with a connection to the oil reservoir, a connection to the suction side of the pump, and a connection to the pressure side of the pump being connected. In that case it is preferably provided that the control valve is a 3/3 directional flow control valve.

The control valve preferably includes a valve position in which the suction side of the pump is connected to the oil reservoir through a flow restriction, and the connection of the selector valve that is connected to the pressure side of the pump is blocked. The control valve preferably includes an additional valve position in which the pressure side of the pump is connected to the suction side of the pump, and the connection of the selector valve that is connected to the oil reservoir is blocked or is connected to the pressure side or suction side of the pump. The control valve preferably includes an additional valve position in which the suction side of the pump is connected to the oil reservoir without throttling by the flow restriction integrated into the valve, but with rotational-speed-dependent throttling by the suction side flow restriction, and connection of the selector valve that is connected to the pressure side of the pump is blocked.

The hydraulic system preferably includes an oil cooler, in particular an oil cooler that is situated between the pressure side of the pump and the wet clutch, wherein a branch to the connection of the pressure side of the pump with the control valve in the direction of flow is situated behind the oil cooler. Preferably, it is also provided that the hydraulic system includes an oil filter, in particular an oil filter that is situated between the oil reservoir and the selector valve. Situated on the suction side of the pump, by preference, is a suction side restriction, which is preferably situated downstream from the selector valve.

Preferably, a check valve is provided to be situated at the oil inlet of the wet clutch, which check valve is situated, by preference, between the oil inlet of the wet clutch and a junction that forms a branch for the bypass. The check valve preferably opens in the direction of flow from the junction to the oil inlet, where the check valve preferably opens in the direction of flow at a minimum pressure, the minimum pressure being greater than the maximum suction pressure of the wet clutch. The minimum pressure can be approximately 0.2 bar, for example.

The problem identified earlier is also solved by a selector valve for use in a hydraulic system in accordance with the invention, wherein the selector valve includes a valve spool that is pressed into one of the valve positions by a spring having a spring characteristic that is graduated over the spring excursion. Preferably, the spring having a spring characteristic that is graduated over the spring excursion is a parallel connection of at least two springs of differing spring lengths when the springs are in a non-loaded state. Also preferably, the control valve is a 3/directional valve, with a connection to the oil reservoir, a connection to the suction side of the pump, and a connection to the pressure side of the pump being connected.

Preferably, it is further provided that the control valve is a 3/3 directional flow control valve, wherein the control valve includes a valve position in which the suction side of the pump is connected to the oil reservoir through a restriction, and the connection of the selector valve that is connected to the pressure side of the pump is blocked. The control valve also includes a valve position in which the pressure side of the pump is connected to the suction side of the pump, and the connection of the selector valve that is connected to the oil reservoir is either blocked or is likewise connected to the pressure side or the suction side of the pump. A further valve position is provided in which the suction side of the pump is connected to the oil reservoir without throttling, and the connection of the selector valve that is connected to the pressure side of the pump is blocked.

Alternatively, the control valve is a 4/directional flow control valve, in particular a 4/3 directional flow control valve, with a connection to the oil reservoir, a connection to the suction side of the pump, a connection to the pressure side of the pump, and a connection to the oil inlet of the wet clutch. In another alternative, the control valve is a 5/directional flow control valve, in particular a 5/3 directional flow control valve, having two connections to the oil reservoir, a connection to the suction side of the pump, a connection to the pressure side of the pump, and a connection to the oil inlet of the wet clutch.

Compared to a control valve situated on the pressure side of the pump, in the solution in accordance with the present invention a second solenoid is eliminated. After the pump and a possible oil cooler, the oil stream is again passed through the control valve, so a shut-off function for the oil can be placed very close to the wet clutch. In the hydraulic system in accordance with the invention, two arrangements with two functional variants can be realized. On the one hand, at the control valve the oil stream coming from the pump can optionally be fed to the clutch or to the tank. Alternatively, the oil stream can optionally be fed to the clutch, or it can be returned to the suction side of the pump by means of a bypass. In both cases, a valve with three selector positions is needed. Contrary to conventional valve arrangements with three functional ranges or selector positions, here, additionally, a so-called proportional magnet is dispensed with. A pure solenoid is used instead, so that the selector valve also can occupy only three distinct selector positions, and not any random intermediate positions. The selector position is realized by a spring arrangement having two springs instead of one spring. The second spring is prestressed in such a way that it acts as a stop at a medium level of force, or at a medium magnetic current of the solenoid. With an additional increase in force or current the prestressing force is overcome and the valve switches to its third position.

### BRIEF DESCRIPTION OF THE DRAWINGS

The structure, operation, and advantages of the present invention will become further apparent upon consideration of the following description, taken in conjunction with the accompanying drawings in which:

FIG. 1 is a schematic representation of a first exemplary embodiment of a hydraulic system in accordance with the invention for supplying oil to a wet clutch;

FIG. 2 is a hydraulic circuit diagram for the exemplary embodiment shown in FIG. 1;

FIG. 3 is a schematic representation of a second exemplary embodiment of a hydraulic system in accordance with the invention for supplying oil to a wet clutch;

FIG. 4 is a hydraulic circuit diagram for the exemplary embodiment shown in FIG. 3;

FIG. 5 is a hydraulic circuit diagram of a third exemplary embodiment of a hydraulic system in accordance with the invention;

FIG. 6 is a hydraulic circuit diagram of a fourth exemplary embodiment of a hydraulic system in accordance with the invention;

FIG. 7 is a longitudinal cross-sectional view of the 3/3 directional flow control valve in the hydraulic circuit shown in FIGS. 5 and 6 when in a first valve position;

FIG. 8 is a longitudinal cross-sectional view similar to FIG. 7 showing a second valve position of the 3/3 directorial valve;

FIG. 9 is a longitudinal cross-sectional view similar to FIG. 7 showing a third position of the 3/3 directional valve;

FIG. 10 is a graph showing the actuator force F over the stroke s of the valve spool; and

FIG. 11 is a schematic representation of a hydraulic system in accordance with FIG. 3 including a check valve.

### DESCRIPTION OF THE PREFERRED EMBODIMENTS

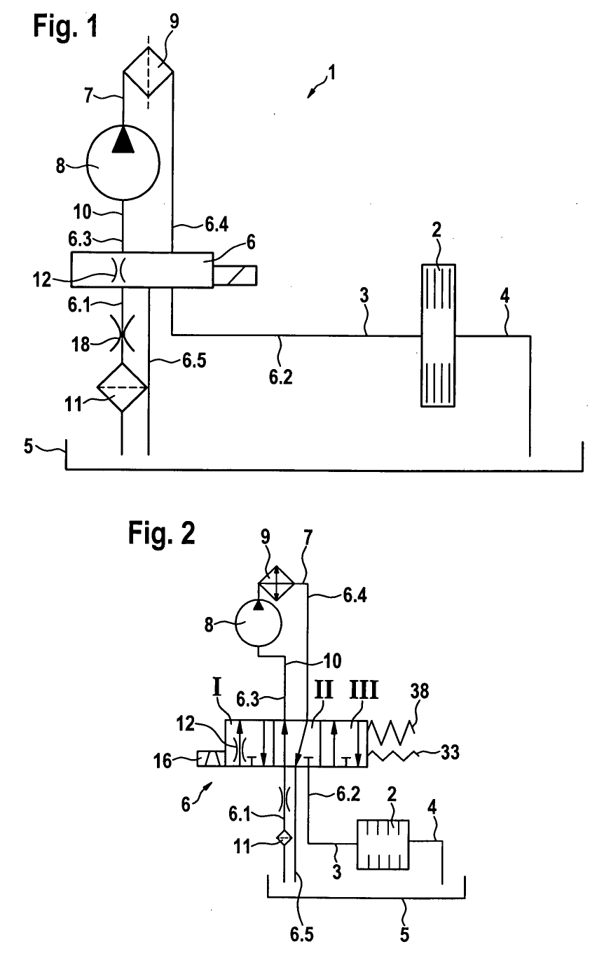

FIG. 1 shows a basic layout sketch and FIG. 2 a hydraulic circuit diagram of a first exemplary embodiment of a hydraulic system 1 for supplying a wet clutch 2 with a hydraulic oil as oil or as a cooling medium and lubricant. The representation in FIG. 2 and the following drawing figures follows the customary manner of representation in DIN ISO 1219, i.e., a valve is represented by a rectangle, individual valve positions are represented by squares, valve connections are lines extending from the basic body of the valve, couplings of the valve connections with each other are represented by arrows, blocked valve connections are represented by a T, and a restriction effect in the direction of flow is represented by two opposed curved lines adjacent to the flow-through arrow. The hydraulic oil is, in particular, cooling oil, which can be kept in a separate clutch circuit or which belongs to the lubricating oil circuit, for example that of a transmission. The transmission itself is not shown.

The wet clutch is situated in a known manner as a single clutch or a double clutch in the power train of a motor vehicle, between a crankshaft (not shown) of an internal combustion engine and the input shaft of a reduction gear or the input shafts of a double-clutch transmission. In a double-clutch transmission there are of course two wet clutches present. For the sake of simplicity, only one wet clutch 2 is shown in the exemplary embodiment of FIG. 1 and in all subsequent exemplary embodiments. Both the transmission of torque and the actual clutch operation are not represented in the exemplary embodiments; only the coolant and lubricant circuits, referred to subsequently as the hydraulic circuit, are explained herein. The wet clutch, or a housing of the wet clutch 2, includes an oil inlet 3 through which the oil is fed under pressure, as well as an oil outlet 4 through which the oil is carried off into an oil reservoir 5. Oil reservoir 5 can be an oil sump, for example, or a similarly designed region of the clutch housing within which oil is maintained. Oil inlet 3 is connected to the pressure side 7 of a pump 8 through a control valve 6 and an oil cooler 9. Suction side 10 of pump 8 is connected to oil reservoir 5 through an additional outlet of control valve 6 through an oil filter 1.

Control valve 6 in the exemplary embodiment of FIG. 1 is a 5/directional valve. Valve 6 includes a connection 6.3 that is connected to the suction side 10 of pump 8, a connection 6.4 that is connected to the outlet of oil cooler 9, which, in turn, is connected to the pressure side 7 of pump 8, a connection 6.1 that is connected to oil reservoir 5 through restriction 18 and oil filter 11, a connection 6.5 that is connected directly to the oil reservoir, and a connection 6.2 that is connected to oil inlet 3 of wet clutch 2.

In the exemplary embodiment shown in the hydraulic circuit diagram of FIG. 2, the control valve 6 is a 5/3 directional valve, so that it includes three different valve positions. In a first valve position I, connection 6.1 is connected to connection 6.3 through a restriction 12, and connection 6.4 is connected directly to connection 6.2, so that a direct flow of cooling liquid takes place through oil filter 11, pump 8 and oil cooler 9 to wet clutch 2, and back again from wet clutch 2 to oil reservoir 5. Restriction 12 is integrated into a control spool of control valve 6, for example, in order to fulfill the function of a suction side flow restriction. In a second valve position II, the same throughput takes place between connection 6.1 and connection 6.3 as in the previously-described valve position; however, the function of the restriction 12 is deactivated, for example it is bypassed. Also in second valve position II, connection 6.4 is connected to connection 6.5 instead of to connection 6.2; thus the oil is not conducted to the wet clutch, but is returned directly back to oil reservoir 5. In a third valve position III, connection 6.1 is connected to connection 6.3, connection 6.5 is blocked, and connection 6.4 is connected to connection 6.2 to conduct oil to wet clutch 2.

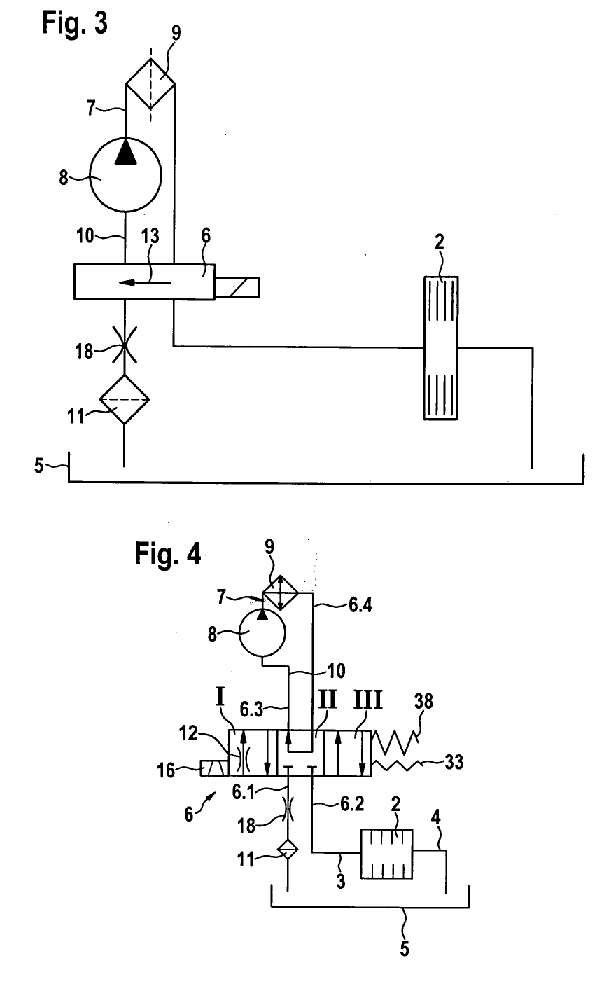

FIGS. 3 and 4 show an additional exemplary embodiment of a hydraulic system in accordance with the invention. In that embodiment the control valve is a 4/3 directional valve. A connection 6.1 is connected to oil reservoir 5, a connection 6.3 is connected to the suction side 10 of pump 8, a connection 6.4 is connected to the pressure side 7 of pump 8, and a connection 6.2 is connected to oil inlet 3 of wet clutch 2. In contrast to the exemplary embodiment of FIGS. 1 and 2, in valve position II shown in FIG. 4, in which wet clutch 2 is not to be pressurized with oil, the oil is not returned to oil reservoir 5, but, instead, is returned by way of a bypass from pressure side 7 back to suction side 10 of pump 8. That flow direction is represented by an arrow 13 in FIG. 3 and by a link between connections 6.3 and 6.4 in valve position II shown in FIG. 4.

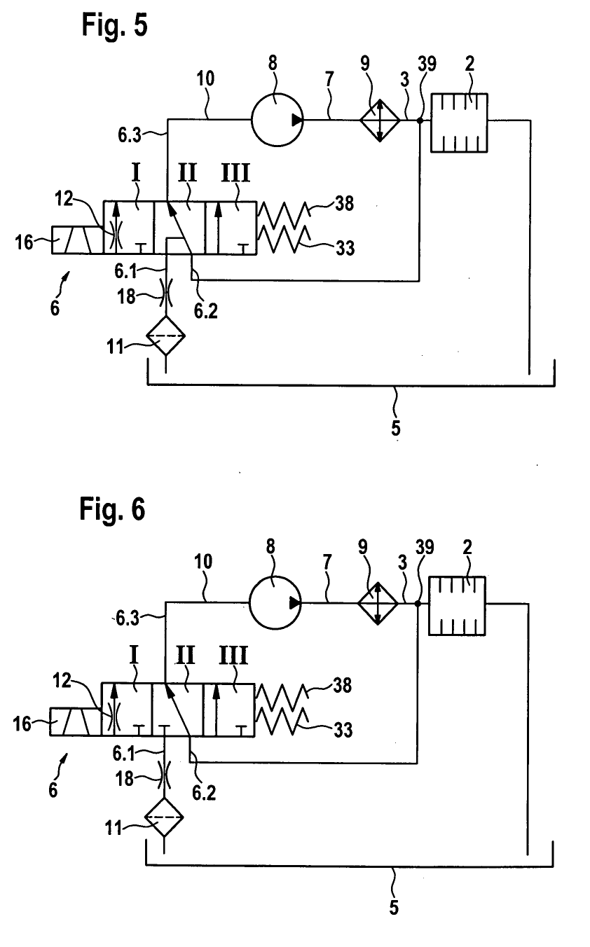

FIGS. 5 and 6 show additional exemplary embodiments of a hydraulic system in accordance with the invention. The hydraulic circuit diagrams in FIGS. 5 and 6 follow in principle the exemplary embodiments of FIGS. 1 through 4; oil is fed from oil reservoir 5 through control valve 6, through a pump 8 and an oil cooler to wet clutch 2, and from there is returned to oil reservoir 5. Control valve 6 includes three connections, which are identified as 6.1, 6.2, and 6.3. A valve spool has drilled holes, grooves, recesses, or the like, in order to link various connections to each other hydraulically in various spool positions. Connection 6.1 is connected to oil reservoir 5 via restriction 18 and oil filter 11. Connection 6.2 is connected to a junction 39 (branching) between oil inlet 3 of wet clutch 2 and oil cooler 9. Connection 6.3 is connected to the suction side 10 of pump 8, whose pressure side 7 is connected through oil cooler 9 to oil inlet 3 of wet clutch 2.

Control valve 6 shown in FIGS. 5 and 6 is a 3/3 directional valve. The three positions of the valve spool are designated as I, II, and III. In valve position I of each of FIGS. 5 and 6, connection 6.1 is connected to the suction side 10 of pump 8 through a restriction 12 that is integrated into control valve 6. Connection 6.2 is blocked. In valve position II in the exemplary embodiment of FIG. 6, connection 6.2 is connected to connection 6.3, so that oil inlet 3 is directly connected to the suction side 10 of pump 8; pump 8 is thereby short-circuited. In the exemplary embodiment of FIG. 5, connection 6.2 is also connected to connection 6.3; but, in addition, connection 6.1 is connected to connection 6.2. That set of connections also causes pump 8 to be short-circuited; but at the same time the pump circuit is also connected to oil reservoir 5. That set of connections enables the valve to be advantageously built with short switching distances. In valve position III of each of FIGS. 5 and 6, connection 6.1 is connected to connection 6.3 without there being any additional restriction effect, and connection 6.2 is blocked. So in valve position I a flow of oil takes place through wet clutch 2 via a restriction 12, in valve position II pump 8 is short-circuited, and in valve position III a flow of oil takes place through wet clutch 2 without restriction 12 exhibiting a throttling effect. In valve position I a minimum volumetric flow of oil flows through wet clutch 2, in valve position II no oil flows through wet clutch 2, and in valve position III a volumetric flow of oil that depends on the pumping capacity of pump 8 and suction restriction 18 flows through wet clutch 2.

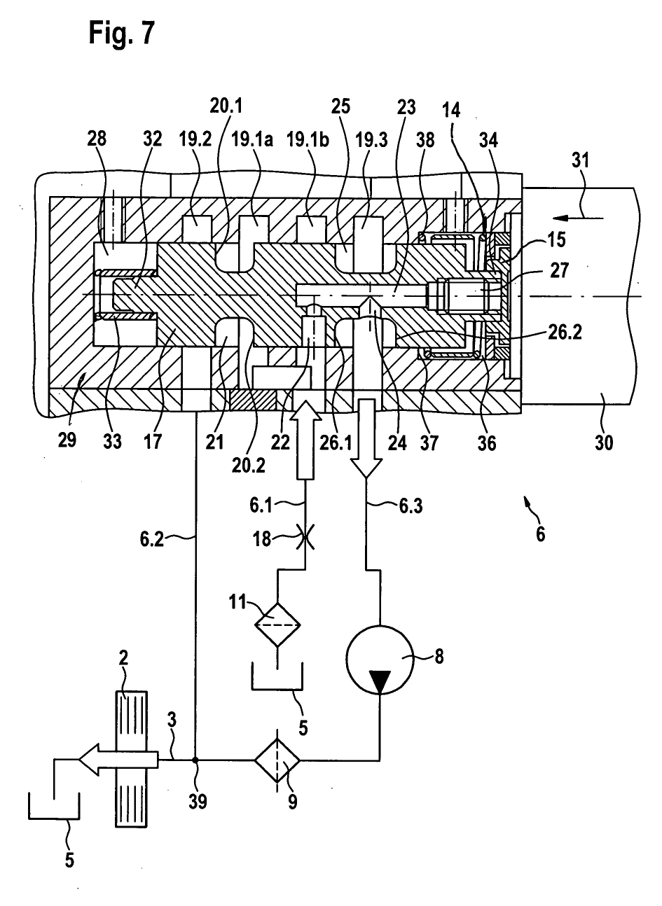

Referring to FIG. 7, control valve 6 is pressed by a first spool spring 33 and a second spool spring 38 into one of its end positions, here selector position I, as the home position. Spool springs 33, 38 are situated in such a way that a movement from selector position I to any intermediate position of the valve spool takes place against the force of first spool spring 33. When valve position II, the middle position, is reached, the second spool spring 38 also contacts the valve spool, so that the restoring force acting on the valve spool increases rapidly. Spool springs 33 and 38 together form a spring combination with a spring characteristic that is graduated over the spring excursion, which thus has a first, lower spring constant over a first spring excursion, in this case the movement of the valve spool from selector position I to selector position II. In valve position II the spring combination exhibits a jump in spring force, and in the further spring excursion, the movement of the valve spool from selector position II to selector position III, the spring combination exhibits a second spring constant. That spring constant condition can come about by connecting two springs in parallel, for example, wherein one of the springs is not activated until after a certain excursion distance of the valve spool has been exceeded. Thus, in the case of compression springs, both springs are compressed and are also prestressed only after that certain excursion distance has been exceeded. A solenoid 16 (see FIG. 2) moves the valve spool of control valve 6 into the two other selector positions, selector positions I and III. When no current is flowing through solenoid 16, valve position I is selected, at medium current flow valve position II is selected, and at maximum current flow valve position III is selected. In contrast to a proportional valve, no regulation of the excursion of the solenoid is needed, since the levels of current flow exhibit such great differences between none, medium, and maximum current flow that control by an unregulated switch is adequate for actuation.

FIGS. 7 through 9 show cross-sectional views of an exemplary embodiment of a control valve 6 in accordance with the invention, in the three different valve positions. Control valve 6 includes bypass recirculation between the suction restriction position for the minimum cooling oil volume, and the suction restriction position for the maximum cooling oil volume. In the normal valve position represented in FIG. 7, the oil in the oil filter 11 (suction side filter) is drawn by pump 8 from a suction restriction (orifice) 18 situated in the suction line of connection 6.1 or within valve spool 17. The connections are designated as 6.1, 6.2, and 6.3, as in the basic layout sketch of FIG. 3. Connection 6.3 is connected through pump 8 and oil cooler 9 to wet clutch 2, which, in turn, is connected to oil reservoir 5. Connection 6.1 is connected to oil reservoir 5 via suction side restriction 18 and oil filter 11. Connection 6.2 is connected to a junction 39 between oil inlet 3 and oil cooler 9.

Valve spool 17 includes a plurality of control edges that work together with segments that adjoin the connections 6.1, 6.2, and 6.3. Associated with connection 6.2 is a segment 19.2, which is designed here as an inner peripheral annular groove. Associated with connection 6.1 are two segments 19.1a and 19.1b, which are connected to each other hydraulically and are likewise designed as inner peripheral annular grooves. Associated with connection 6.3 is a segment 19.3, which likewise is designed as an inner peripheral annular groove.

Valve spool 17 includes a first control edge 20.1 and a second control edge 20.2, between which a first, outer peripheral annular groove 21 is situated. First control edge 20.1 works together with first segment 19.1, and second control edge 20.2 works together with second segment 19.1a. By shifting valve spool 17, a hydraulically conducting connection can be produced between the segments 19.1a and 19.1b. In addition, valve spool 17 includes a first transverse bore 22, which leads into another outer peripheral annular groove 25 through an axial bore 23 and a second transverse bore 24. Second outer peripheral annular groove 25 includes control edges 26.1 and 26.2. Axial bore 23 is sealed against the outside by a threaded plug 27.

The substantially cylindrical valve spool 17 is received in a cylindrical bore 28 of a valve housing. When current is applied, a solenoid 30 exerts an operating force F on valve spool 17 in the direction of arrow 31. At its end facing away from solenoid 30, valve spool 17 includes a peg 32 over which first spool spring 33 is placed, which presses against valve housing 29. Movement of valve spool 17 in the direction of arrow 31 is possible against the force of first spool spring 33. Another peg 34 is situated on the side facing solenoid 30. In valve housing 29, situated on the side facing solenoid 30 there is a shouldered hole 36, which has a larger inside diameter than the outside diameter of valve spool 17. Second spool spring 38, which is also in the form of a compression spring, is supported against a floor 37 of shouldered bore 36 and valve spool 17.

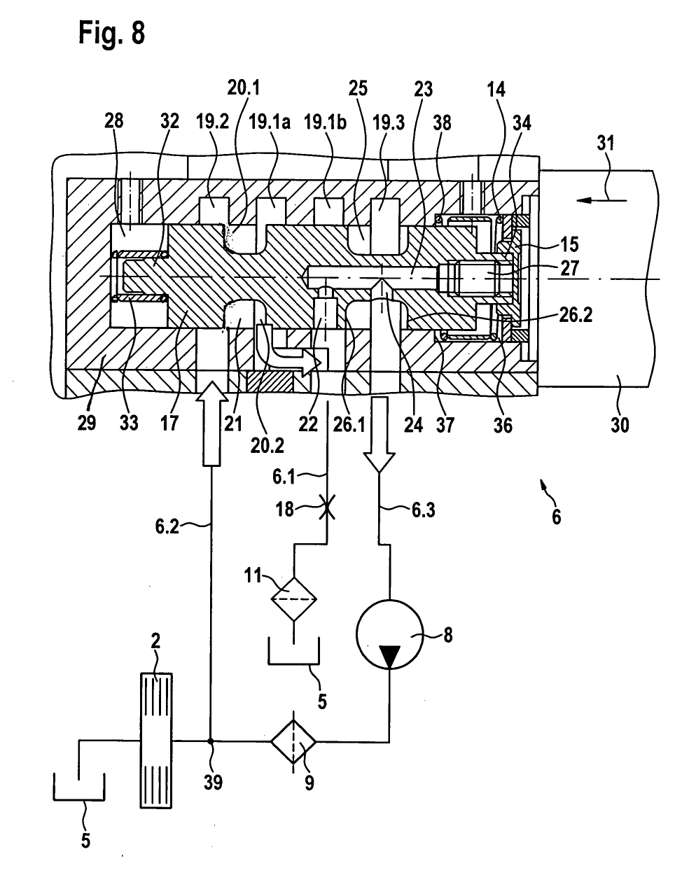

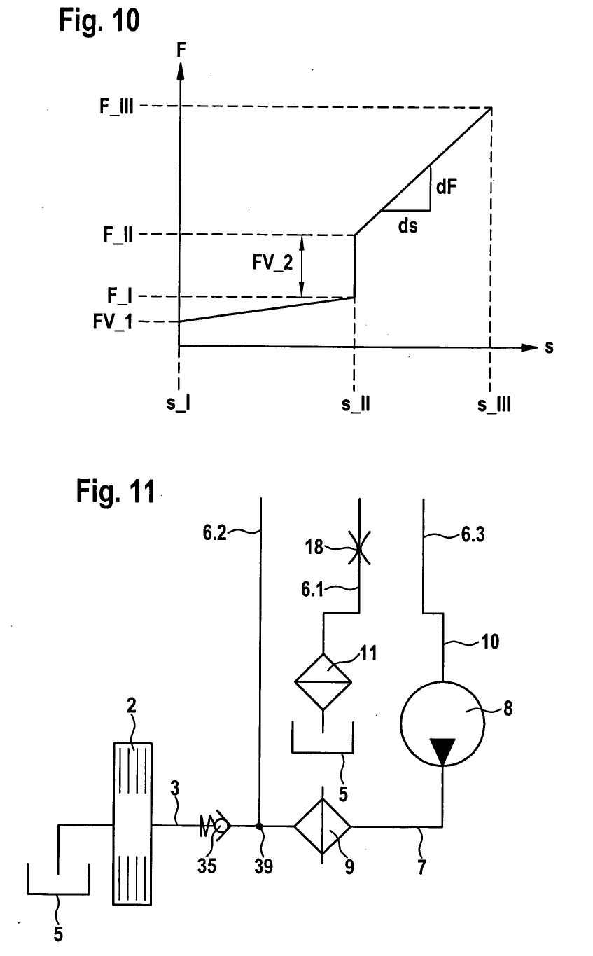

FIG. 7 shows position I of control valve 6 in accordance with FIGS. 5 and 6. In that valve position, valve spool 17 is in its right-hand end position, where right-hand refers to the plan view in accordance with the representation in FIG. 7. Thus, valve spool 17 is in the end position in which it is moved as far as possible toward solenoid 30. That end position is reached through the effect of first spool spring 33, which presses valve spool 17 into the right-hand end position. The first spool spring 33 is biased for that purpose, so that it exerts a force on valve spool 17 even when the latter is in its endmost position. In valve position I a stream of oil flows through connection 6.1 to connection 6.3. Connection 6.2 is blocked. First transverse bore 22, together with axial bore 23 and second transverse bore 24, form restriction 12 shown in FIGS. 5 and 6. If solenoid 30 is activated, a movement of valve spool 17 takes place in the direction of arrow 31 against the force of first spool spring 33. Second spool spring 38 works together with a plate spring 14 and a spring carrier 15. Plate spring 14 and spring carrier 15 come into contact only after a certain regulating distance, as explained below on the basis of FIG. 10. In the middle position shown in FIG. 8, which corresponds to valve position II, plate spring 14 and spring carrier 15 come into direct contact; with further movement of valve spool 17 in the direction of arrow 31 second spool spring 38 is compressed further. Second spool spring 38 is also biased, and is stiffer than first spool spring 33.

In valve position II shown in FIG. 8, which is the middle position of valve spool 17, connection 6.2 is connected through segment 19.2, outer peripheral annular groove 21 and segment 19.1a to segment 19.1b, and thereby to connection 6.1. The latter, in turn, is connected through bores 22, 23, and 24 to segment 19.3, and thereby to connection 6.3. Thus, connection 6.2 is connected to connection 6.3, so that a bypass is available for pump 8. The oil is thus now pumped by pump 8 only through the bypass; restriction 12, which is formed from bores 22, 23 and 24, limits the volumetric flow. No volumetric flow takes place any longer to wet clutch 2.

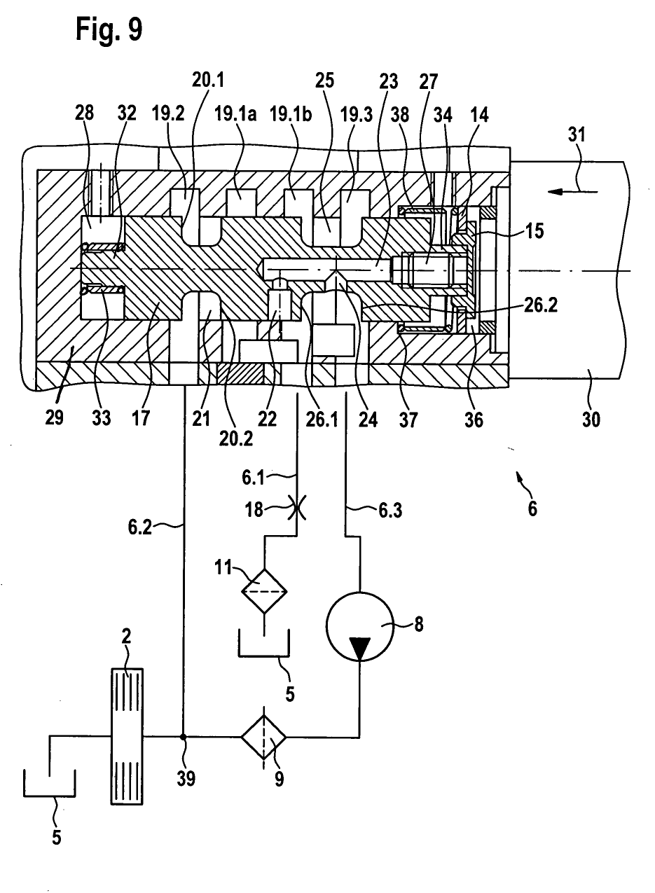

Finally, FIG. 9 shows valve position III, the left-hand end position of valve spool 17. To reach valve position III, it is necessary to overcome not only the force of first spool spring 33, but also the spring force of second spool spring 38. That requires a significantly greater force than that needed to overcome the spring force of first spool spring 33 alone. In that valve position connection 6.2 is blocked. Instead, connection 6.1 is connected through segment 19.1b and second outer peripheral annular groove 25 directly to segment 19.3, and thereby to connection 6.3. In that valve position, pump 8 draws oil through oil filter 11 from oil reservoir 5 without throttling within valve 6, which oil is conveyed on the pressure side 7 of pump 8 through oil cooler 9 to wet clutch 2, and from there back again to oil reservoir 5.

First spool spring 33 and second spool spring 38 are arranged in such a way that until the middle position is reached (selector position II) only the force of first spool spring 33 must be overcome, and to reach the left-hand end position (selector position III) the force of second spool spring 38 must also be overcome. The second spool spring 38 is first compressed only after a distance s_II (see FIG. 10) of valve spool 17 has been traveled, so that that spring exerts an additional restoring force on valve spool 17 only after distance s_II has been exceeded. When there is no current to solenoid 30, selector position I (i.e., the right-hand end position in accordance with FIGS. 7 through 9) is assumed due to the force of first spool spring 33. Thus, when there is no current flowing to the solenoid, valve spool 17 is in position I, with medium current flowing to solenoid 30 valve spool 17 is in position II, and with maximum current to solenoid 30 valve spool 17 is in position III. The difference between medium current flow and maximum current flow to solenoid 30 is so great that no regulation of the current flow is necessary. Thus selector valve 6 is not operated as a proportional valve, but as a pure selector valve.

The actuator force F needed to move the valve spool over a travel distance s is represented in the graph of FIG. 10. For a spool position s_I (valve position I) the actuator force needed begins with the biasing force FV_1 of first spool spring 33, and increases linearly over the distance s to a distance s_II at a force F_I. By adding second spool spring 38 at s_II (valve position II), the force increases rapidly by the biasing force FV_2 of second spool spring 28, to a level F_II. The remainder of the spring characteristic is the result of a parallel connection of each of spool springs 33 and 38. The actuator force to trigger the middle position s_II (valve position II) can be anywhere between the forces F_I and F_II. Accordingly, the level of current to the solenoid can be comparatively imprecise, and valve position II will still be selected reliably. To trigger endmost position III of spool 17 (valve position III) the current level is increased further to provide a force F_III to overcome the combined effect of both spool springs 33, 38 and to move the spool from point s_II to point s_III.

FIG. 11 shows an exemplary embodiment of a hydraulic system in accordance with the invention, with a check valve 35 between oil inlet 3 of wet clutch 2 and junction 39. For the sake of clarity, only the hydraulic connections of control valve 6 corresponding with FIGS. 3 through 6 are shown. Check valve 35 opens in the direction of flow from junction 39 to oil inlet 3, and blocks flow in the opposite direction. Check valve 35 has a low opening pressure of 0.2 bar, for example. The opening pressure is designed so that in operating situations in which wet clutch 2 builds up inlet side pressure the oil in valve position II can be supplied reliably to the suction side 10 of pump 8. The opening pressure to do so is higher than the maximum inlet side (under)pressure that can be built up by wet clutch 2 at oil inlet 3. As a result, check valve 35 closes as soon as control valve 6 is in valve position II.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A hydraulic system for supplying a hydraulic fluid to a wet clutch, said hydraulic system comprising: a pump for delivering hydraulic fluid from a fluid reservoir to a wet clutch and having a suction side and a pressure side; an electromechanically operated flow control valve that is actuated by a solenoid for controlling hydraulic fluid flow through the hydraulic system; wherein the control valve is positioned on the suction side of the pump and is a selector valve that can be shifted to different flow conditions and that includes a valve position in which a pressure side of the pump is selectively connected to one of the suction side of the pump and to the fluid reservoir.

2. A hydraulic system in accordance with claim 1, wherein the control valve includes a displaceable valve spool that is pressed into a home position by a spring means having a spring characteristic that is varied over a spring travel distance.

3. A hydraulic system in accordance with claim 2, wherein the spring means is a parallel connection of at least two springs, wherein one of the springs is acted on only after a predetermined travel distance of the valve spool is exceeded.

4. A hydraulic system in accordance with claim 1, wherein the control valve is a 4/directional valve, wherein a first connection is connected to the hydraulic fluid reservoir, a second connection is connected to the suction side of the pump, a third connection is connected to the pressure side of the pump, and a fourth connection is connected to a hydraulic fluid inlet of the wet clutch.

5. A hydraulic system in accordance with claim 1, wherein the control valve is a 5/directional valve, wherein first and second connections are connected to the hydraulic fluid reservoir, a third connection is connected to the suction side of the pump, a fourth connection is connected to the pressure side of the pump, and a fifth connection is connected to a hydraulic fluid inlet of the wet clutch.

6. A hydraulic system in accordance with claim 1, wherein the control valve is a 3/directional valve, wherein a first connection is connected to the hydraulic fluid reservoir, a second connection is connected to the suction side of the pump, and a third connection is connected to the pressure side of the pump.

7. A hydraulic system in accordance with claim 6, wherein the control valve is a 3/3 directional valve.

8. A hydraulic system in accordance with claim 7, wherein the control valve includes a first valve position in which the suction side of the pump is connected through the first connection to the hydraulic fluid reservoir through a restriction, and the third connection of the valve that is connected to the pressure side of the pump is blocked.

9. A hydraulic system in accordance with claim 7, wherein the control valve includes a second valve position in which the pressure side of the pump is connected to the suction side of the pump, and the first connection of the selector valve that is connected to the hydraulic fluid reservoir is selectively one of a blocked condition and a condition wherein it is connected to the pressure side and to the suction side of the pump.

10. A hydraulic system in accordance with claim 7, wherein the control valve includes a third valve position in which the suction side of the pump is connected to the hydraulic fluid reservoir through a flow restriction, and the third connection of the valve that is connected to the pressure side of the pump is blocked.

11. A hydraulic system in accordance with claim 1, including a hydraulic fluid cooler that is positioned between the pressure side of the pump and the wet clutch, and including a branch conduit extending from a connection downstream of the hydraulic fluid cooler to a valve connection in communication with the pressure side of the pump.

12. A hydraulic system in accordance with claim 1, including a hydraulic fluid filter that is positioned between hydraulic fluid reservoir and the control valve.

13. A hydraulic system in accordance with claim 1, including a flow restriction positioned on the suction side of the pump.

14. A hydraulic system in accordance with claim 13, wherein the flow restriction is situated upstream of the control valve.

15. A hydraulic system in accordance with claim 1, including a check valve positioned adjacent the hydraulic fluid inlet of the wet clutch.

16. A hydraulic system in accordance with claim 15, wherein the check valve is positioned between the hydraulic fluid inlet of the wet clutch and a junction of a first conduit that extends between the pump outlet and the wet clutch and a second conduit that extends to the control valve.

17. A hydraulic system in accordance with claim 16, wherein the check valve opens in a flow direction extending from the junction to a hydraulic fluid inlet of the wet clutch.

18. A hydraulic system in accordance with claim 17, wherein the check valve opens in the direction of flow at a minimum pressure that is greater than a maximum inlet side pressure of the wet clutch.

19. A hydraulic system in accordance with claim 18, wherein the minimum pressure is approximately 0.2 bar.

20. A control valve for use in a hydraulic system in accordance with claim 1, wherein the control valve includes a valve spool that is pressed into a home position by a spring means having a spring characteristic that is graduated over a spring excursion distance.

21. A control valve in accordance with claim 20, wherein the spring means is a parallel connection of at least two springs, where one of the at least two springs is acted on only after a predetermined travel distance of the valve spool is exceeded.

22. Control valve in accordance with claim 21, wherein the control valve is a 3/directional valve, wherein a first connection is connected to the hydraulic fluid reservoir, a second connection is connected to the suction side of the pump, and a third connection is connected to the pressure side of the pump.

23. Control valve in accordance with claim 22, wherein the control valve includes a first valve position in which the suction side of the pump is connected through a restriction to the hydraulic fluid reservoir and a connection of the valve that is connected to the pressure side of the pump is blocked, and a second valve position in which the pressure side of the pump is connected to the suction side of the pump and a connection of the valve that is connected to the hydraulic fluid reservoir is blocked, and a third valve position in which the suction side of the pump is connected to the hydraulic fluid reservoir through a flow restriction and a connection of the selector valve that is connected to the pressure side of the pump is blocked or is connected to the pressure side or the suction side of the pump.

24. A control valve in accordance with claim 20, wherein the control valve is a 4/directional valve, wherein a first connection is connected to the hydraulic fluid reservoir, a second connection is connected to the suction side of the pump, a third connection is connected to the pressure side of the pump, and a fourth connection is connected to a hydraulic fluid inlet of the wet clutch.

25. A control valve in accordance with claim 20, wherein the control valve is a 5/directional valve, wherein first and second connections are connected to the hydraulic fluid reservoir, a third connection is connected to the suction side of the pump, a fourth connection is connected to the pressure side of the pump, and a fifth connection is connected to a hydraulic fluid inlet of the wet clutch.
